(19) United States
(12) Patent Application Publication
(10) Pub. No.: US 2018/0290561 A1
(43) Pub. Date: Oct. 11, 2018

(54) USE OF AN AUTONOMOUS RANGE EXTENDER VEHICLE AND AUTONOMOUS RANGE EXTENDER VEHICLE

(71) Applicant: BVB INNOVATE GmbH, Stuttgart (DE)

(72) Inventor: Manfred Baumgärtner, Stuttgart (DE)

(21) Appl. No.: 15/721,732

(22) Filed: Sep. 29, 2017

Related U.S. Application Data
(63) Continuation of application No. PCT/EP2016/056900, filed on Mar. 30, 2016.

(30) Foreign Application Priority Data
Mar. 31, 2015 (DE) 10 2015 205 811.5

(51) Int. Cl. B60L 15/38; B60L 11/18; G05D 1/02

(52) U.S. Cl. CPC B60L 15/38; B60L 11/182; G05D 1/021; B60L 2200/28; H02J 7/0013; B60L 2200/36; G05D 2201/0213; B60L 2260/32; B60L 2240/62

(57) ABSTRACT

Use of a range extender vehicle includes a range extender energy store and means for transmitting energy to a main vehicle for supplying a main vehicle, including a main vehicle electric motor for driving the main vehicle, a main vehicle energy store for supplying the main vehicle electric motor with power and means for obtaining energy from the range extender vehicle, with energy from the range extender energy store via the coupled-together energy transmission means and means for obtaining energy. The range extender vehicle also includes: a range extender electric motor for driving the range extender vehicle; means for autonomously driving the range extender vehicle on a road network; and receiving means for receiving information for detecting the main vehicle. By means of the invention, the mobility, in particular the range, of electric vehicles can be improved in a simple and comfortable manner.

### CROSS-REFERENCE TO RELATED APPLICATIONS

This continuation application claims priority to PCT/EP2016/056900 filed on Mar. 30, 2016 which has published as WO 2016/156383 A1 and also the German application number 10 2015 205 881.5 filed on Mar. 31, 2015, the entire contents of which are fully incorporated herein with these references.

### FIELD OF THE INVENTION

The invention relates to a use of a range extender vehicle having a range extender energy store and means for transmitting energy to a main vehicle, in order to supply a main vehicle, having a main vehicle electric motor for driving the main vehicle, a main vehicle energy store for supplying the main vehicle electric motor with current and means for obtaining energy from the range extender vehicle, with energy from the range extender energy store via the mutually coupled means for transmitting energy and means for obtaining energy.

### BACKGROUND OF THE INVENTION

The spread of electrically driven motor vehicles which are considered to be environmentally friendly is limited by the maximum range thereof which is often inadequate. The maximum achievable range of electric vehicles is substantially limited by the capacity of the fitted batteries. Currently available passenger vehicles with an electric drive typically have nominal ranges in the range from approximately 50 to 200 km. In practice, however, these values are often not achieved as a result of different influencing factors. In order to increase the range of electric vehicles, different approaches referred to with the key word “Range Extender” have been proposed.

DE 10 2008 006 332 A1 describes a trailer range extender which has a power supply unit which is integrated in a trailer, wherein the trailer is connected to a trailer coupling of a motor vehicle. The power supply unit can in this instance comprise an accumulator set, a super-capacitor or a fuel cell unit. An operating current of the power supply unit is supplied via an operating current line and via a plug type connection to an operating current system of an electric vehicle. An electrical configuration for a trailer range extender is described in DE 10 2012 011 960 A1.

DE 10 2012 015 099 A1 proposes special relay stations for a rapid change of trailer-based range extenders, in particular with columns which can be retracted and to which range extenders are connected, respectively. With a single trailer range extender in which the power supply unit is constructed as a lithium ion or lithium iron phosphate battery, the range of an electric vehicle can be extended by approximately from 200 to 300 km.

A disadvantage in such trailer range extenders is particularly that they have to be manually connected to the electric vehicle which is intended to be supplied and manually disconnected from the electric vehicle. It is further necessary to actively bring the trailer range extenders for charging with the electric vehicle to suitable charging stations and to fetch the recharged trailer range extenders from that location. This involves additional logistical and time complexity for a driver of the electric vehicle.

DE 10 2012 214 750 A1 describes a system for supplying energy to an electric vehicle, wherein an autonomous charging vehicle having a current collector for a sliding contact with an overhead line is used. The charging vehicle and the electric vehicle are connected and disconnected to/from each other at a coupling station; the connection can be carried out automatically or semi-automatically. A connection device comprises a connection head, which is engaged around in a positive-locking manner by a locking device on a pivotable articulated arm. In a variant, a positioning unit of the connection device is provided for rapid disconnection and can be actuated when threshold values for the vehicle acceleration are exceeded. In another variant, there is provision for the charging vehicle to be able to drive autonomously to a parking location.

### SUMMARY OF THE INVENTION

### OBJECT OF THE INVENTION

An object of the invention is to improve the mobility, in particular the range, of electric vehicles in a simple and comfortable manner.

### BRIEF DESCRIPTION OF THE INVENTION

This object is achieved by using a range extender vehicle of the type described in the introduction which is characterised in that the range extender vehicle further has
a range extender electric motor for driving the range extender vehicle,
means for autonomously driving the range extender vehicle on a road network and
receiving means for receiving information for locating the main vehicle.

It is thereby possible for the range extender vehicle to automatically drive up to the main vehicle and to supply it with electrical energy. Similarly, the range extender vehicle can automatically return to a charging station, where it can be recharged for further use. Therefore, it is no longer necessary for the main vehicle to visit the location of a charged range extender vehicle in order to couple to it. It is also no longer necessary to bring back a range extender vehicle with a substantially depleted energy store to a charging station.

The term “energy store” is intended to be understood here to mean any device for providing electrical energy, for example, galvanic cells. The energy store may be in particular any type of rechargeable store for electrical energy, including electrochemical accumulators (such as lithium ion accumulators) or capacitors. The energy store may also comprise a fuel cell having a fuel store.

The main vehicle may, for example, be a lorry, a passenger vehicle, an agricultural or commercial utility vehicle or towing vehicle or a special-purpose vehicle. The main vehicle electric motor and the main vehicle energy store may be the sole means for driving the main vehicle. However, the main vehicle may also be constructed as a hybrid vehicle having an additional drive device. In particular a parallel or serial hybrid drive having an additional internal combustion engine or a fuel cell of the main vehicle is possible. Mixed forms such as a power-branching hybrid drive are also conceivable.

The receiving means typically function wirelessly. Information received for locating the main vehicle is preferably direct information relating to the location of the main vehicle, but may also be directional information and/or distance information or driving instructions, with which (starting from the current location of the range extender vehicle) the range extender vehicle can approach the main vehicle.

The road network, on which the range extender vehicle can drive autonomously (driverlessly) is preferably a public road network. However, the road network may also be a private road network which is delimited from the public road network, for example, on commercial premises or an agricultural useful area. The range extender vehicle is typically constructed without any driver's cab and without local manual driving control devices; typically, no persons are on-board. In order also to be able to move the range extender vehicle beyond the road network by means of the range extender electric motor, in special cases a workplace for a driver of the range extender vehicle can be constructed.

In A. Lari et al., “Self-Driving Vehicles: Current Status of Autonomous Vehicle Development and Minnesota Policy Implications”, provided for publication in the Minnesota Journal of Law, Science and Technology, August 2014, download from http://tpec.umn.edu/publications/whitepapers/documents/self_driving_cars.pdf, an overview of the fundamentals of autonomous driving is set out; a range extender vehicle can be constructed and operated accordingly in the context of the invention.

### Preferred Embodiments of the Invention

In a preferred variant of the use according to the invention, there is provision for the supply of the main vehicle with energy from the range extender energy store to be carried out while the main vehicle is parked at a parking position, wherein the main vehicle energy store is recharged, in particular by high-speed charging. The main vehicle energy store can thereby be recharged without the main vehicle having to be parked at parking spaces (charging stations) which are specially configured therefor. Instead, the range extender vehicle can visit the main vehicle at a parking position which is freely selectable in principle and supply it with energy. In this variant, the coupling and decoupling is simplified because it can be carried out with the main vehicle in a static state.

Advantageously, a development of this variant makes provision for pieces of information to be communicated to the range extender vehicle in order to locate the parking position via the receiving means before, during or after the arrival of the main vehicle at the parking position, and for the range extender vehicle to drive autonomously to the parking position. Subsequently, the means for transmitting energy and the means for obtaining energy are coupled, which can be carried out manually or (preferably) automatically. A manual interaction with the range extender vehicle can be avoided with automatic coupling or at least reduced. When the parking position is communicated before the main vehicle reaches the parking position, the range extender vehicle can reach the parking position earlier and accordingly start recharging earlier, which accordingly restores the range of the main vehicle more quickly.

An alternative variant of the use is also preferred in which the supply of the main vehicle with energy from the range extender energy store is carried out while the main vehicle drives on the road network. As a result, an additional energy reservoir can be made available during the travel of the main vehicle and the range of the main vehicle can be extended. In principle, the main vehicle energy store no longer limits the range of the main vehicle.

A development of this variant is advantageous, in which, while the main vehicle is driving,
the range extender vehicle drives up to the main vehicle autonomously using information received via the receiving means, and subsequently the means for transmitting energy and the means for obtaining energy are automatically coupled to each other, and/or
the means for transmitting energy and the means for obtaining energy are automatically decoupled and subsequently the range extender vehicle autonomously drives away from the main vehicle. A range extender vehicle can, in particular, be requested by the main vehicle only when the need is identified during travel. The travel is not interrupted for the coupling and/or decoupling. The range extender vehicle is coupled during travel to the (substantially) charged range extender energy store; it is subsequently used to supply the main vehicle. A range extender vehicle with a (substantially) depleted range extender energy store is decoupled during travel. Range extender vehicles can be kept so as to be distributed in a state parked on the road network, in particular at charging stations for the range extender vehicles; however, it is also possible to keep range extender vehicles ready in a state driving on the road network in order to be at a requesting main vehicle particularly quickly.

A development is particularly preferred, in which there is provision for, while the main vehicle is driving, a plurality of range extender vehicles successively
to drive up to the main vehicle autonomously using information which is received via the receiving means, and subsequently the means for transmitting energy and the means for obtaining energy are coupled to each other automatically, and
the means for transmitting energy and the means for obtaining energy are automatically decoupled and subsequently the range extender vehicle autonomously drives away from the main vehicle. Therefore, different (substantially) charged range extender vehicles can be successively coupled to a main vehicle without interrupting the travel and provide (transmit) energy of the range extender energy store thereof, and are decoupled again after the (substantial) discharge thereof (“flying changes”), which allows practically endless ranges of the main vehicle without travel interruptions.

In an advantageous development, there is provision for the energy for a propulsion current of the main vehicle electric motor to be provided by the range extender energy store while supplying the main vehicle with energy from the range extender energy store, preferably wherein the energy for a charging current for recharging the main vehicle energy store is further also provided by the range extender energy store. If the transmitted energy store of the range extender energy store is substantially used (for example, by more than 90%) directly as propulsion current for the main vehicle, the main vehicle energy store can be selected to be relatively small; the range extender vehicle then accompanies the main vehicle typically during the majority of the travel path thereof (where applicable, with flying changes of the range extender vehicle). In particular in the case of a relatively large main vehicle energy store, it may alternatively also be advantageous to carry out a (rapid) charge of the main vehicle energy store during travel and accordingly to accompany the main vehicle with the range extender vehicle only during a short portion of the travel path thereof (where applicable also several times one after the other); in this case, the transmitted energy store of the range extender energy store is typically substantially (for example, by more than 60%) used to recharge the main vehicle energy store.

A development is also preferable in which, during the supply of the main vehicle with energy from the range extender energy store, the range extender vehicle and the main vehicle are fixed to each other via a non-positive-locking and/or positive-locking connection, in particular when the range extender electric motor is switched off. This variant is particularly suitable for transmitting energy via a plug type connection. In this case, there is no need to control the main vehicle electric motor and the range extender electric motor in a synchronised manner.

In an alternative, advantageous development, there is provision, during the supply of the main vehicle with energy from the range extender energy store, for the range extender vehicle and the main vehicle to maintain only a resilient abutment contact in the travel direction, wherein the range extender vehicle drives autonomously. This variant is particularly suitable for a wireless (preferably inductive) energy transmission. In this instance, it is possible to configure a coupling which is particularly simple to establish and to release in respect of the means for transmitting energy and for obtaining energy. Typically, the range extender vehicle constantly measures the (relative) position of the main vehicle in order to maintain the relative position with respect to the main vehicle. Alternatively or additionally, transmitted position information and/or speed information of the main vehicle can also be used.

A development is particularly preferred in which there is provision for the range extender vehicle to give up a coupling of the means for transmitting energy and the means for obtaining energy and to configure a spacing between the range extender vehicle and the main vehicle before a defined travel path portion is reached or a defined travel situation occurs, to further maintain a spacing between the range extender vehicle and the main vehicle as long as the defined travel path portion is being passed or the defined driving situation continues, and to configure the coupling of the means for transmitting energy and the means for obtaining energy again when the defined travel path portion has been left again or the defined driving situation has passed. Typically, there are stored in a map a large number of defined path portions which would cause particular mechanical loads or overloads on the coupling of the main vehicle and the range extender vehicle and accordingly must not be travelled through in a coupled state. As a result of the above method, the defined travel path portions (for example, particularly tight bends or rough road surfaces) can be readily passed. The range extender vehicle can use its own position determination for checking the defined travel path portions (for example, via GPS) or use a position of the main vehicle which is communicated via the receiving means. Alternatively or additionally, particular driving situations (for example, evasive manoeuvres or overtaking manoeuvres) which would overload the coupling can be readily passed through. The envisaged variant for use is particularly suitable for only resilient abutment contact of the main vehicle and the range extender vehicle because this contact can be rapidly released and established again. When the abutment contact (or another type of coupling) is lost, the main vehicle can no longer be supplied via the range extender energy store so that at corresponding times use has to be made of the main vehicle energy store. A corresponding driving situation can be identified or initiated and communicated by the main vehicle. Alternatively, the range extender vehicle can also have its own sensor system for identifying the driving situation; typically, a communication to the main vehicle that the coupling has been released or re-established is then carried out.

A development is also advantageous in which the main vehicle also has means for autonomously driving the main vehicle on the road network and in which the main vehicle drives autonomously while the supply of the main vehicle with energy from the range extender energy store is being carried out. If no rest times of a vehicle driver have to be complied with, the advantages of the range extension by range extender vehicles can be used particularly effectively.

A variant of the use is particularly preferred in which the means for transmitting energy and the means for obtaining energy are constructed for a wireless energy transmission, in particular an inductive energy transmission. The inductive energy transmission is easy to couple automatically. Alternatively, plug type connections may also be provided; in this case, however, an automatic coupling is more complex.

A variant of the use is also advantageous in which the main vehicle comprises a lorry. In the case of lorries, a restriction of the useful load and/or the load volume by an energy store, such as a battery for supplying the main vehicle electric motor, is a serious consideration. The use according to the invention of a range extender vehicle may also make it increasingly possible to electrically drive lorries, wherein only a relatively small main vehicle energy store has to be provided.

The scope of the present invention also includes a range extender vehicle, in particular for a use described above, having a range extender energy store and means for transmitting energy to a main vehicle, which is characterised in that the range extender vehicle further has
a range extender electric motor for driving the range extender vehicle,
means for autonomously driving the range extender vehicle on a road network and
receiving means for receiving information for locating the main vehicle. Such a range extender vehicle is particularly suitable for the above-described use. It allows use of a main vehicle with an electric drive in a comfortable manner and with an improved range.

An embodiment of a range extender vehicle according to the invention is advantageous in which the range extender vehicle is constructed without a driver's seat. There are then no concessions necessary in terms of the size of the energy store for the construction of the driver's seat (or even a passenger compartment). As a result of the means for autonomously driving, the range extender vehicle is also not dependent on interventions of a vehicle driver.

An embodiment of a range extender vehicle according to the invention is also preferred in which there is provision for at least 50% of the mass thereof, preferably at least 75% of the mass thereof and/or at least 50% of the volume thereof, preferably at least 75% of the volume thereof, to be allotted to the range extender energy store. The energy store then uses the size (mass or volume) of the range extender vehicle particularly well.

An embodiment is also advantageous in which the means for transmitting energy are constructed for automatically coupling and decoupling to/from means for obtaining energy of the main vehicle. No manual interventions are then necessary for coupling and decoupling. In particular, coupling and decoupling during travel may be possible.

An embodiment is particularly preferred in which the means for transmitting energy are constructed for a wireless energy transmission to means for obtaining energy of the main vehicle, in particular for an inductive energy transmission. It is then particularly readily possible to automatically couple and decouple; usually, a given mutual approach or simple mutual abutment is sufficient for a coupling.

A development of this embodiment is advantageous in which the means for transmitting energy comprise an induction loop in an abutment element. The main vehicle has a counter-element for abutting the abutment element. An induction loop is also integrated in the counter-element. The counter-element can be constructed as a bumper of the main vehicle or be integrated in a bumper of the main vehicle. This allows substantial integration of the means for obtaining energy in already-present structures of the main vehicle. The inductive energy transmission is relatively efficient and reliable to handle.

An embodiment is also preferred in which there is provision for the means for transmitting energy to have a coupling element which is arranged on one or more resilient extension arms which can be deployed mechanically parallel with the travel direction, in particular wherein the coupling element is arranged at the front on the range extender vehicle. Furthermore, the coupling element can typically be pivoted via one or more articulations, in particular ball joints or double axis elements, and can preferably also be varied in terms of height, for example, by the extension arm(s) themselves being fixed to the range extender vehicle so as to be vertically displaceable or pivotable about a horizontal axis. The means for obtaining energy on the main vehicle have a corresponding mating coupling element (typically fixed to the main vehicle). Thus, a mechanically protective abutment contact of the coupling element and the mating coupling element can be configured. The coupling element is preferably an abutment element with an induction loop for a resilient abutment contact with respect to a counter-element with an induction loop on the main vehicle; alternatively, plug type counterparts are also possible as the coupling element and mating coupling element.

A development of this embodiment is advantageous in which means for mechanically adjusting the coupling element in terms of height are provided. The coupling element can therefore be adjusted to the height of the mating coupling element on the main vehicle. In particular, adaptation to different types of main vehicles is thereby possible (with a differently positioned mating coupling element).

A development is particularly preferred in which there is provision for one or more magnets to be constructed on the coupling element. The coupling element and mating coupling element can thereby engage with each other automatically during coupling, which is readily possible in particular in the case of construction as an abutment element and counter-element. The main vehicle or the corresponding mating coupling element accordingly preferably has one or more magnets which are arranged with opposite poles. The magnets can readily be constructed as permanent magnets. Alternatively, electromagnets can be provided, whereby the coupling can be released more easily by the electromagnets being switched off.

Other advantages of the invention will be appreciated from the description and the drawings. The above-mentioned features and those set out below can also be used according to the invention individually per se or together in any combination. The embodiments shown and described are not intended to be understood to be a conclusive listing but instead are of exemplary character for describing the invention.

### BRIEF DESCRIPTION OF THE DRAWINGS

The invention is illustrated in the drawings and is explained in greater detail with reference to embodiments. In the drawings:

FIG. 1 is a schematic side view of a range extender vehicle according to the invention during the supply of a self-driving main vehicle;

FIG. 2 is a schematic side view of a range extender vehicle according to the invention during the supply of a manually controlled lorry with a driver's cab;

FIG. 3a is a schematic method diagram of the request for a range extender vehicle according to the invention by a parking main vehicle;

FIG. 3b is a schematic diagram of a use according to the invention of a range extender vehicle for charging a parking main vehicle;

FIG. 4a is a schematic method diagram of the request for a range extender vehicle according to the invention by a driving main vehicle;

FIG. 4b is a schematic diagram of a charging operation with a driving main vehicle;

FIG. 4c is a schematic method diagram of the return of a range extender vehicle according to the invention from a driving main vehicle to a charging station;

FIG. 5a is a schematic method diagram of the coupling of a first range extender vehicle according to the invention to a driving main vehicle;

FIG. 5b is a schematic method diagram of the decoupling of the first range extender vehicle according to the invention from a driving main vehicle and the coupling of a second range extender vehicle according to the invention to the driving main vehicle;

FIG. 6 is a schematic side view of a driving module of a main vehicle;

FIG. 7 is a schematic side view of a range extender vehicle according to the invention with height-adjustable, resiliently supported means for transmitting energy;

FIG. 8 is a schematic plan view of the range extender vehicle of FIG. 7 in a state coupled to a main vehicle;

FIG. 9 is a schematic method diagram of the decoupling and coupling of a range extender vehicle according to the invention to/from a main vehicle during travel over a rough road surface.

### DETAILED DESCRIPTION OF THE PREFERRED EMBODIMENTS

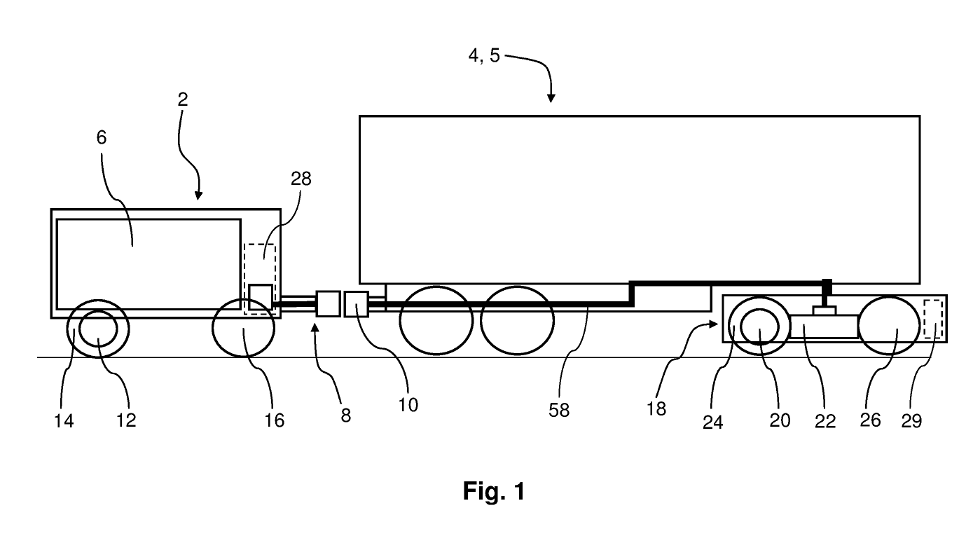

FIG. 1 is a schematic side view of a self-driving range extender vehicle 2 according to the invention which is trailer-like in this instance and which is coupled to a main vehicle 4, wherein the range extender vehicle 2 supplies the main vehicle 4 with current from a range extender energy store 6. In order to configure the current flow, means 8 for transmitting energy of the range extender vehicle 2 (preferably comprising a height-adjustable coupling element with an integrated induction loop) are connected to means 10 for obtaining energy of the main vehicle 4 (preferably comprising a bumper with an integrated induction loop).

The range extender vehicle 2 comprises, in addition to the range extender energy store 6, a range extender electric motor 12 for driving the range extender vehicle 2 and means 28 for autonomously driving. The range extender electric motor 12 acts on a driven axle 14 of the range extender vehicle 2. The range extender vehicle 2 can follow the main vehicle 4 by means of a steered axle 16. The range extender energy store 6 is used here for supplying both the range extender electric motor 12 and the main vehicle 4 with current.

In this case, the main vehicle 4 is constructed as a self-driving lorry 5 without any driver's cab. The self-driving lorry 5 comprises a steerable driving module 18 having a main vehicle electric motor 20, a main vehicle energy store 22 and means 29 for autonomous driving. The driving module 18 further has in this instance a main drive axle 24 and a main steering axle 26.

Via the means 8 for transmitting energy and the means 10 for obtaining energy and a current feed line 58, current is transmitted from the range extender energy store 6 to the main vehicle energy store 22 and/or to the main vehicle electric motor 20. The range extender energy store 6 takes up approximately 75% of the volume and more than 75% of the mass of the range extender vehicle 2 in this case. In particular, the range extender energy store 6 is in this case constructed to be substantially larger (preferably with an energy store which is at least 5 times larger) than the main vehicle energy store 22. A volume of the main vehicle 4 can thereby be used as a useful volume to an extremely predominant degree, whereas a drive system of the main vehicle 4 together with a main vehicle energy store has only a comparatively small spatial requirement. By the main vehicle 4 being supplied by the range extender vehicle 2 with current from the range extender energy store 6, a sufficiently great range of the main vehicle 4 can nevertheless be achieved.

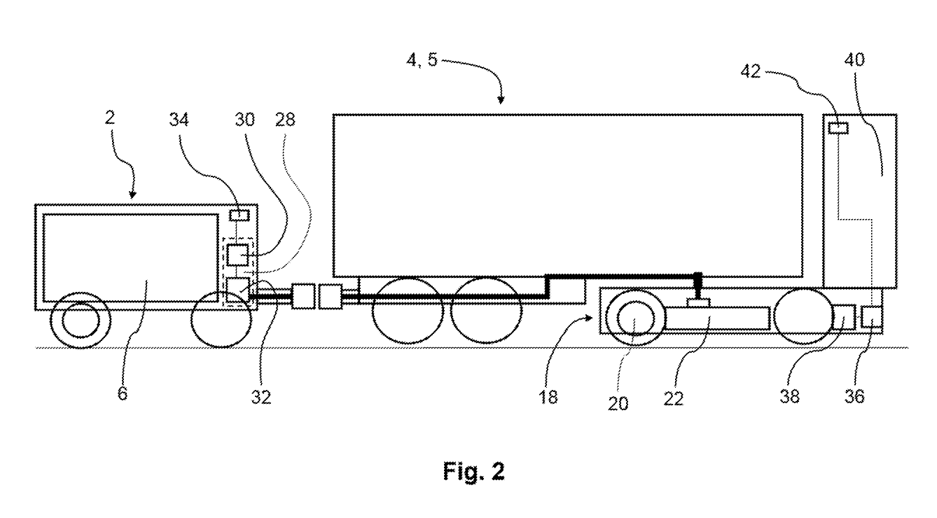

FIG. 2 is a schematic side view of a range extender vehicle 2 according to the invention during the supply of a main vehicle 4 which is constructed here as a manually controlled lorry 5.

The range extender vehicle 2 comprises means 28 for autonomous driving. The means 28 for autonomous driving comprise in particular an automatic motor control unit 30 (“Electronic Control Unit”, ECU) and an automatic steering device 32 of the range extender vehicle 2. The means 28 for autonomous driving can communicate wirelessly with the main vehicle 4 and/or a cloud database via a first gateway 34; in particular location information concerning the main vehicle 4 can be obtained. The means 28 for autonomous driving typically also comprise a device for establishing the position of the range extender vehicle 2 and a route planning system (“navigation system”) (not illustrated in greater detail). Since the range extender vehicle 2 is constructed for autonomous driving, it does not have in this instance any driver's seat or any other type of device for manually steering directly on the range extender vehicle 2. However, the range extender vehicle 2 can be influenced via the gateway 34 externally, in particular by human interaction, if, for example, a device for establishing the position fails or the range extender vehicle 2 is on the way in uncharted territory.

A driving module 18 of the main vehicle 4 has in this case, in addition to a main vehicle electric motor 20, a device 36 for motor control and a device 38 for steering. In this case, there is arranged on the driving module 18 a driver's cab, from which a vehicle driver can act on the device 36 for motor control and the device 38 for steering. Via a second gateway 42 the main vehicle 4 and the range extender vehicle 2 can communicate with each other directly in the sense of a car-to-car communication or indirectly via an interface module of the cloud database. In particular, information concerning a charging state of a range extender energy store 6 and a main vehicle energy store 22 can be exchanged.

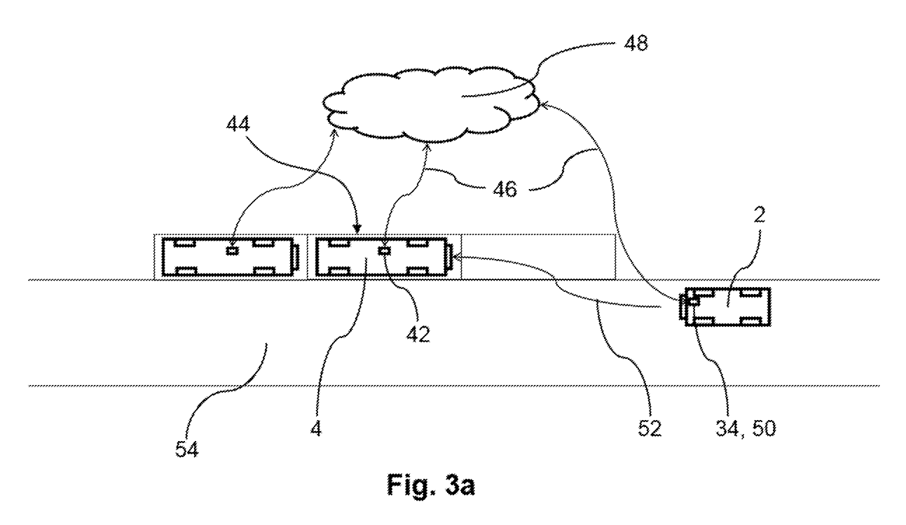

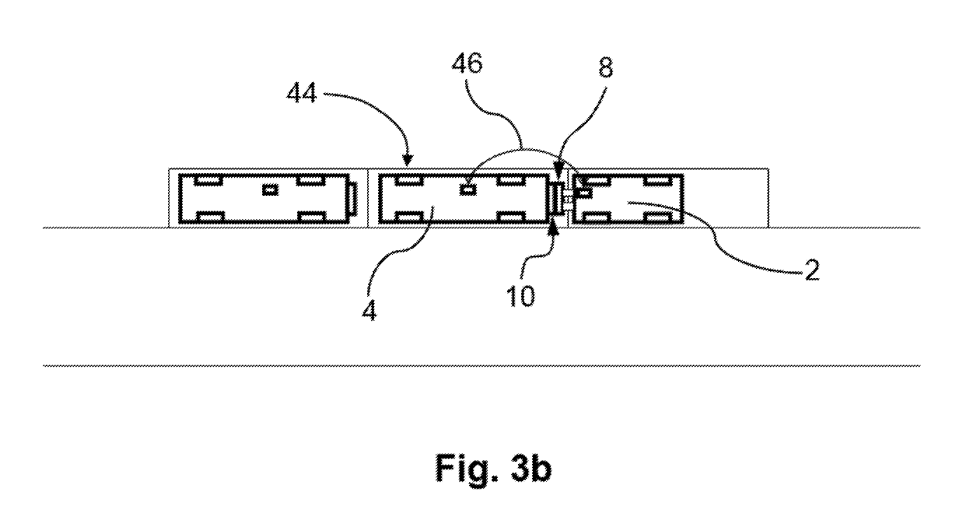

FIG. 3a schematically illustrates how a main vehicle 4 located in a parking position 44 requests a range extender vehicle 2. To this end, the main vehicle 4 transmits via a second gateway 42 information concerning a radio connection 46 to a cloud database 48 (with application software). The information can include in particular data relating to locating the parking position 44 and the energy requirement of the main vehicle 4.

The range extender vehicle 2 receives this information from the cloud database 48 via a first gateway 34. The first gateway 34 consequently acts as a receiving means 50 for receiving information for locating the main vehicle 4. The range extender vehicle 2 subsequently drives autonomously to the main vehicle 4 which is parked in the parking position 44. A travel path 52 of the range extender vehicle 2 leads in this instance over a road network 54, here a public road network.

FIG. 3b schematically shows a charging operation for a parked main vehicle 4. After the range extender vehicle 2 has arrived at the parking position 44 of the main vehicle 4, means 8 for transmitting energy of the range extender vehicle 2 are coupled to means 10 for obtaining energy of the main vehicle 4. A charging current flows from a range extender energy store (not illustrated) into a main vehicle energy store (not illustrated) via the coupled means 8 for transmitting energy and the means 10 for obtaining energy.

During the charging operation, the main vehicle 4 and the range extender vehicle 2 can communicate with each other via a radio connection 46 in the sense of a car-to-car communication. The car-to-car communication can also be carried out in a wired manner in place of the radio connection, in particular if plug counterparts are coupled to each other for transmitting current between the range extender vehicle 2 and the main vehicle 4. In particular information concerning the progress of the charging operation can be exchanged via the radio connection 46. When the main vehicle energy store is charged again sufficiently, preferably completely, the main vehicle 4 communicates this to the range extender vehicle 2. The range extender vehicle 2 can then seek another main vehicle if it still has sufficient energy reserves or can itself return to a charging station.

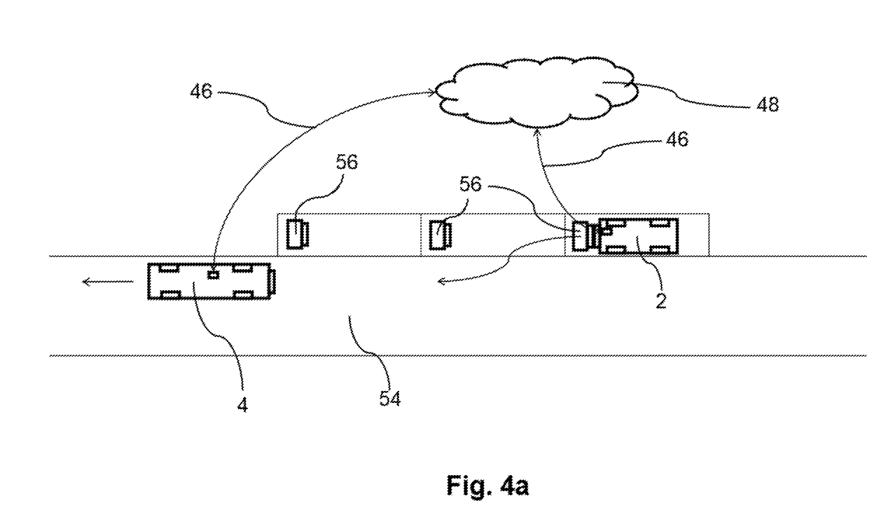

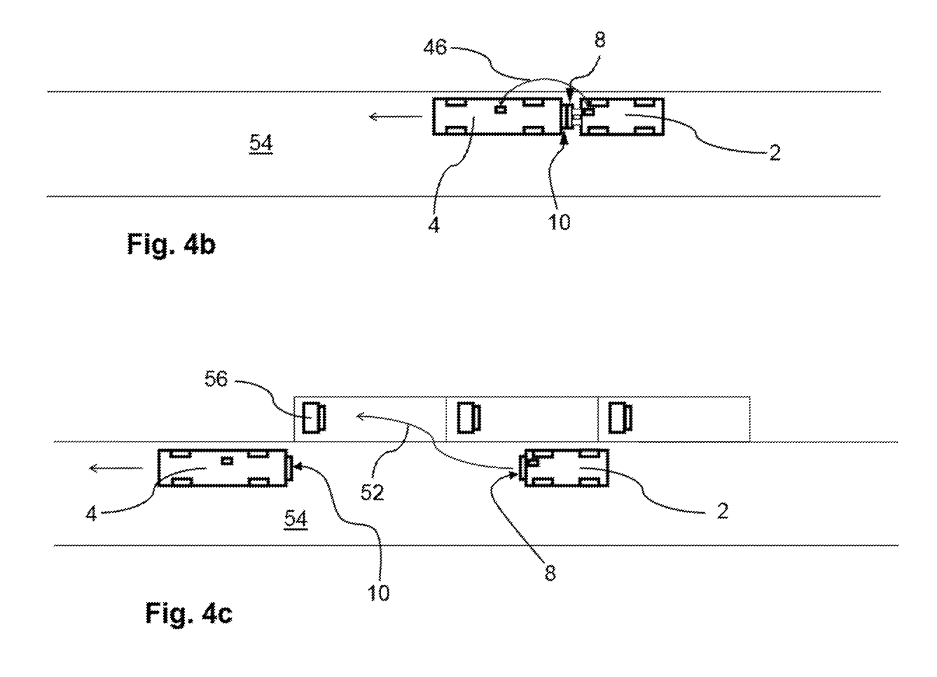

FIG. 4a schematically illustrates how a main vehicle 4 which is driving on a road network 54 requests a range extender vehicle 2. As soon as the main vehicle identifies that the energy store in a main vehicle energy store (not illustrated) is not sufficiently great to reach a destination, the main vehicle 4 reports its energy requirement and its position via a radio connection 46 in the sense of a “machine-to-machine” communication (M2M) to a cloud database 48 which cooperates with a piece of application software.

The application software of the cloud database 48 establishes a range extender vehicle 2 which is available and is located near the main vehicle 4. In this case, the range extender vehicle 2 is located at a charging station 56 in an environment of the road network 54. The cloud database transmits via the radio connection 46 to the range extender vehicle 2 information for locating the main vehicle 4, in particular the position and planned driving route thereof. The range extender vehicle 2 then leaves the charging station 56 and drives autonomously on the road network 54 in order to visit the main vehicle 4.

In this case, the charging station 56 is constructed as a retractable charging device. In particular, the charging station 56 can be retracted in the ground so as to be flush in this case. Furthermore, the charging station 56 is constructed to withstand in a retracted configuration the load of vehicles which drive over the retracted charging station 56, in particular range extender vehicles 2 or main vehicles 4. Retracting the charging station 56 in the ground can then make it possible for the range extender vehicle 2 to be able to readily drive forwards onto the road network 54. A complex maneuvering and reversing of the range extender vehicle 2 can thereby be avoided. Furthermore, a floor space at the charging station 56 with the charging station 56 retracted can also be used as a parking space for larger vehicles, for example, main vehicles 4.

FIG. 4b illustrates how the range extender vehicle 2 supplies current to the main vehicle 4 during travel on the road network 54. After the range extender vehicle 2 has reached the main vehicle 4, means 8 for transmitting energy of the range extender vehicle 2 are connected to means 10 for obtaining energy of the main vehicle 4. Current is transmitted from the range extender vehicle 2 to the main vehicle 4 via the coupled means 8 for transmitting energy and means 10 for obtaining energy.

The means 8 for transmitting energy and means 10 for obtaining energy can in this case be connected to each other in a non-positive—locking and/or positive-locking manner, for example, by a clamping device or a bolt. The range extender electric motor can then be switched off so that the range extender vehicle 2 is pulled by the main vehicle (or pushed in the case of coupling from the front).

Alternatively, the means 8 for transmitting energy and means 10 for obtaining energy can maintain only resilient abutment contact. The range extender vehicle 2 then follows the main vehicle 4 autonomously. In this case, information concerning a driving state and intended or already-initiated changes to the driving state is preferably continuously exchanged via the radio connection 46 between the main vehicle 4 and the range extender vehicle 2. Optionally or additionally, there may also be provision for the range extender vehicle 2 to measure, in particular constantly measure, a relative position in relation to the main vehicle 4 and to adapt the driving state thereof accordingly in order to sufficiently precisely comply with a desired position relative to the main vehicle 4.

The current transmitted can be used both directly to drive the main vehicle 4 and to recharge a main vehicle energy store (not illustrated). Meanwhile, the main vehicle 4 and range extender vehicle 2 can communicate with each other via a radio connection 46.

FIG. 4c illustrates how the range extender vehicle 2 returns to a charging station 56. After the main vehicle energy store (not illustrated) has been recharged, in particular completely charged, or when the range extender energy store (not illustrated) is almost depleted, the range extender vehicle 2 and the main vehicle 4 are released from each other. The means 8 for transmitting energy and the means 10 for obtaining energy are automatically decoupled from each other for this purpose. The range extender vehicle 2 then selects a travel path 52 which leads the range extender vehicle 2 via the road network 54 to a charging station 56, at which the range extender energy store (not illustrated) is recharged. After charging the range extender energy store has been carried out, the range extender vehicle 2 is again available for supplying further main vehicles with power.

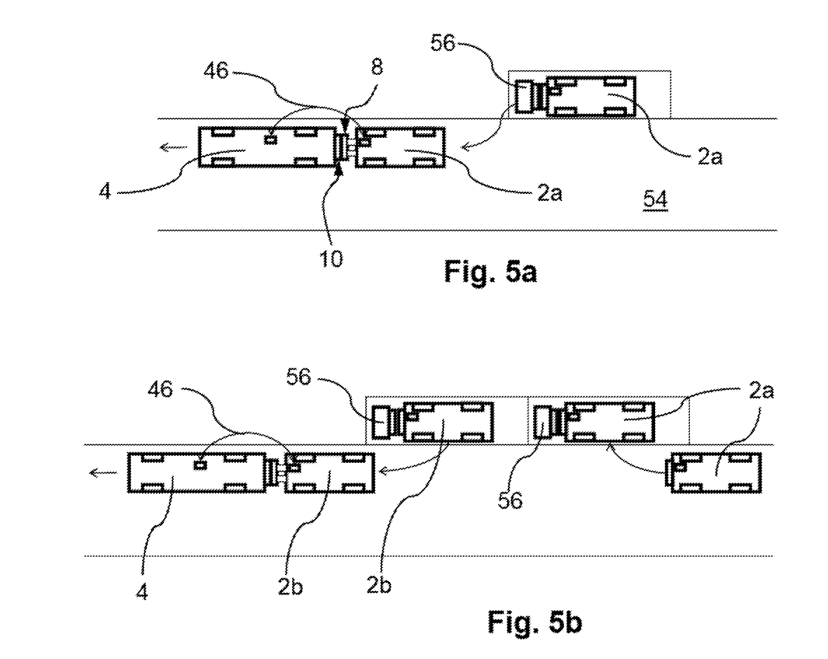

FIG. 5a shows similarly to FIGS. 4a, 4b how a first range extender vehicle 2a approaches a main vehicle 4 which is driving on a road network 54 and supplies current to the main vehicle 4. A range extender energy store (not illustrated) of the first range extender vehicle 2a was previously charged at a charging station 56. At the request of the main vehicle 4, the first range extender vehicle 2a approaches the main vehicle 4. As soon as the first range extender vehicle 2a has reached the main vehicle 4, means 8 for transmitting energy and means 10 for obtaining energy are coupled to each other. Meanwhile, a radio connection 46 allows communication between the first range extender vehicle 2a and the main vehicle 4. In particular, the first range extender vehicle 2a communicates to the main vehicle 4 when a range extender energy store (not illustrated) of the first range extender vehicle 2a will probably be depleted.

FIG. 5b schematically shows how a second range extender vehicle 2b is coupled to the main vehicle 4 and supplies current to the main vehicle 4. Beforehand, the first range extender vehicle 2a has communicated to the main vehicle 4 via the radio connection 46 that an energy store in a range extender energy store of the first range extender vehicle 2a is running short. Subsequently, the main vehicle 4 has requested a second range extender vehicle 2b.

The first range extender vehicle 2a then automatically decouples from the main vehicle 4 and heads towards a charging station 56 in an environment of the road network 54. At the same time, the second range extender vehicle 2b drives from a charging station 56 onto the road network 54 and towards the main vehicle 4 in order to supply current to the main vehicle 4.

By repeatedly exchanging the range extender vehicles 2a , 2b during the travel when the energy stores thereof are depleted, in principle an unlimited range of the main vehicle 4 can be made possible. This is particularly useful when the main vehicle 4 is also constructed to drive autonomously on the road network. There can be avoided according to the invention travel interruptions which would otherwise be necessary to refill a main vehicle energy store or to change a non-self-driving range extender or (in the case of a non-self-driving main vehicle) as rest periods for a vehicle driver. It Is thereby possible to reach even remote destinations within the shortest possible time or the main vehicle 4 can be used without interruption with shuttle or ring traffic.

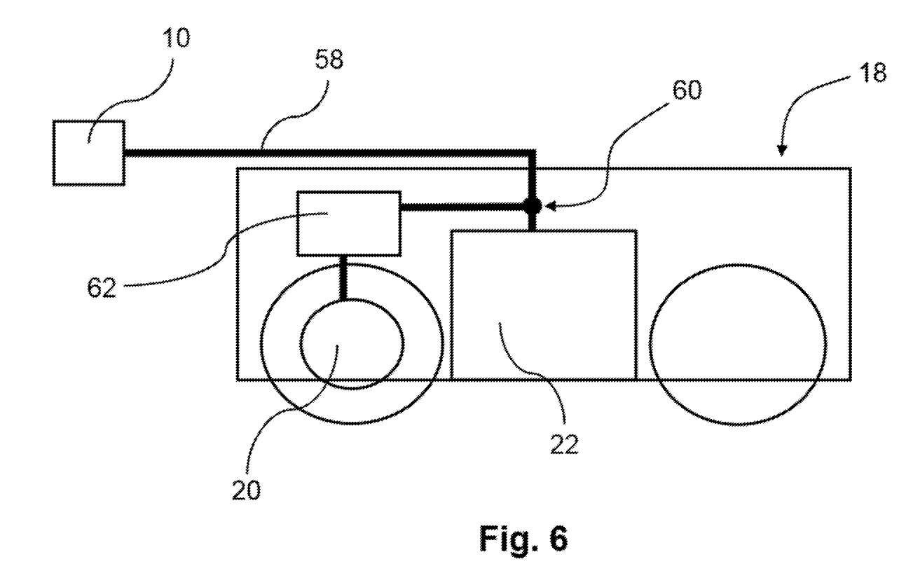

FIG. 6 schematically shows a driving module 18 for a main vehicle (not illustrated) comprising a main vehicle electric motor 20 and a main vehicle energy store 22. Furthermore, a current feed line 58 is arranged on the driving module 18. The current feed line 58 connects means 10 for obtaining energy to a current distributor 60. A current which is provided for the driving module 18 of the main vehicle by a range extender vehicle flows from the means 10 for obtaining energy through the current feed line 58 to the current distributor 60. It is possible to adjust at the current distributor 60 whether the current is to be used to drive the main vehicle electric motor 20 and/or to charge the main vehicle energy store 22. The portion of the current which acts as propulsion current for driving the main vehicle electric motor 20 is directed via an inverter 62 to the main vehicle electric motor 20. The portion of the current which is used to recharge the main vehicle energy store 22 can be supplied to the main vehicle energy store 22 via a charge controller which is integrated in this case in the main vehicle energy store 22. Alternatively, instead of a current distributor, a direct feed into the direct-current circuit of the main vehicle can be carried out. The current distribution is then carried out by selecting a suitable voltage level of the range extender current (preferably by means of a DC/DC converter). Preferably, the voltage level of the range extender supply is to be selected to be slightly higher than the voltage level of a traction battery of the main vehicle energy store so that simultaneously both the propulsion current (traction current) flows primarily from the range extender battery and recharging of the traction battery is carried out.

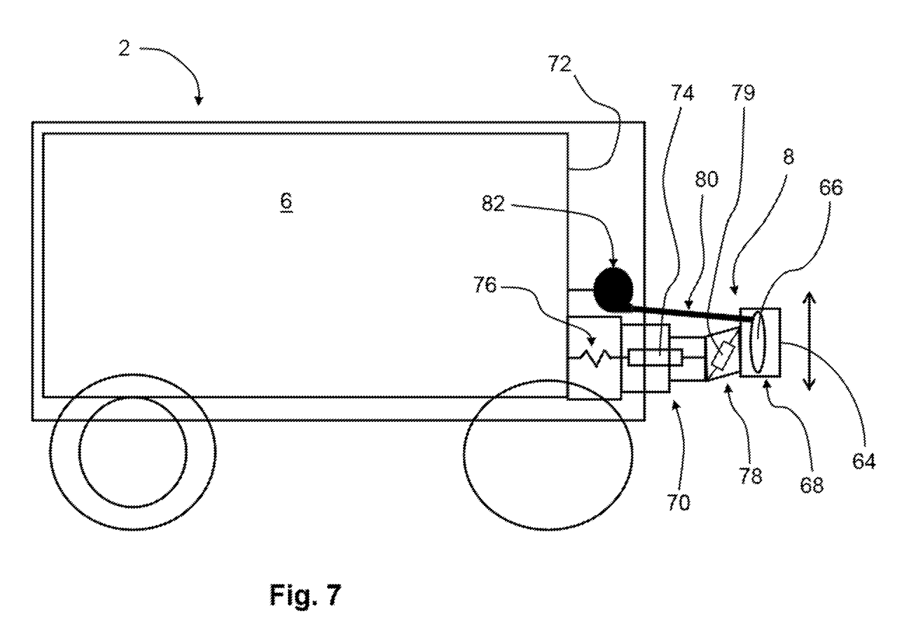

FIG. 7 schematically shows the arrangement of means 8 for transmitting energy on a range extender vehicle 2 according to the invention. The means 8 for transmitting energy comprise here an abutment element 64 with an induction loop 66. The abutment element 64 is integrated in this instance in a coupling element 68 which is arranged at the front of the range extender vehicle 2.

The coupling element 68 is deployed and retracted again via resilient extension arms 70 which are constructed here as a telescope-like device and which can be deployed mechanically in the direction of travel and which are preferably fixed to the chassis of the range extender vehicle 2. In this instance, a position adjustment member 74 and a resilient element 76 are arranged in the telescope-like extension arm 70 in a state connected in series. The telescope-like extension arm 70 can be deployed by means of the position adjustment member 74 in the travel direction from the range extender vehicle 2 and can be brought into contact with means for obtaining energy (not illustrated) of a main vehicle. The resilient element 76 makes it possible to configure a resilient abutment contact between the abutment element 64 of the extension arm 70 and a corresponding counter-element of the main vehicle. The resilient element can particularly compensate for fluctuations in the relative longitudinal position between the range extender vehicle 2 and the main vehicle at least to the extent that they normally occur during travel operation.

In order to be able to adapt the coupling element 68 in the vertical position (height) thereof to a mating coupling element which is generally arranged rigidly on the main vehicle, the extension arm 70 has in this instance means 78 for mechanical height adjustment. The means for mechanical height adjustment are constructed in this case as a four-bar linkage having a diagonally arranged height adjustment member 79. Alternatively, rotary drives and pivot axes can also be used for vertical adjustment.

The induction loop 66 is connected to the range extender energy store 6 via a current feed line 80. The current feed line 80 comprises in this case a cable tension member 82 which ensures that a cable of the current feed line 80 which leads to the induction loop 66 in the coupling element 68 always remains tensioned relative to the housing 72 of the range extender energy store 6 even in the case of a changing longitudinal position of the coupling element 68 during travel. A risk of damage to the current feed line 80 by the cable being jammed or sheared off can thereby be prevented.

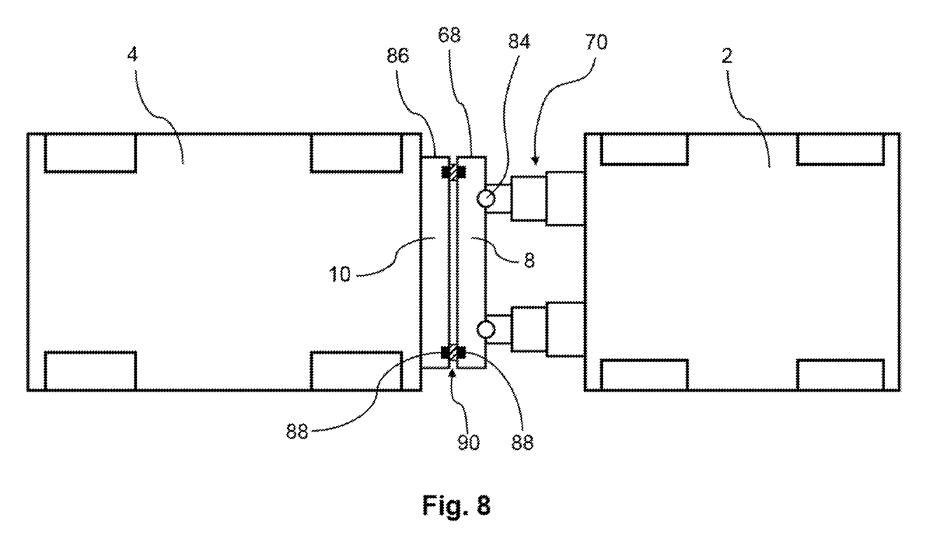

FIG. 8 is a schematic plan view of the range extender vehicle 2 from FIG. 7 in a state coupled to a main vehicle 4. The means 8 for transmitting energy of the range extender vehicle 2 comprise the coupling element 68 which is supported via two extension arms 70 on the range extender vehicle 2. A rotary bearing 84 is arranged between the extension arms 70 and the coupling element 68 in order to configure an ability of the coupling element 68 to rotate about the vertical axis (here perpendicular to the plane of the drawing) with respect to the range extender vehicle 2. It may be possible as a result of the ability to rotate for bends also to be driven round with the means 8 for transmitting energy and the means 10 for obtaining energy being coupled. To this end, an oblique position of the coupling element 68 relative to the range extender vehicle 2 can be configured by the two extension arms 70 being deployed or retracted in a telescope-like manner to different extents.

The means 10 for obtaining energy are constructed in this instance as a mating coupling element 86 which is rigidly integrated in a bumper of the main vehicle 4. In order to be able to configure and maintain a coupling of the coupling element 68 and the mating coupling element 86, magnets 88 are arranged in this case on the coupling element 68 and on the mating coupling element 86. The magnets 88 are constructed here as electromagnets which can be switched off. By the magnets being switched off, decoupling the coupling element 68 from the mating coupling element 86 can then be made easier. Alternatively, the magnets 88 can also be constructed as permanently magnetic coupling magnets. In order to make it easier to couple the coupling element 68 to the mating coupling element 86, there may be provided guides, for example, guide plates which expand in a funnel-like manner or guide rails, on the coupling element 68 and/or on the mating coupling element 86.

In order to prevent damage, such as, for example, scratches in a surface, of the coupling element 68 and the mating coupling element 86, spacers 90 are arranged in this case between the coupling element 68 and the mating coupling element 86. The spacers 90 further set a defined spacing between the coupling element 68 and the mating coupling element 86. It is thereby possible to ensure the operability of the inductive energy transmission. A defined spacing of the partners of a plug type connection is also advantageous in the case of an alternative current transmission via plug counterparts. The spacers 90 can be non-releasably retained either on the coupling element 68 or on the mating coupling element 86. Alternatively, spacers 90 can be arranged both on the coupling element 68 and on the mating coupling element 86.

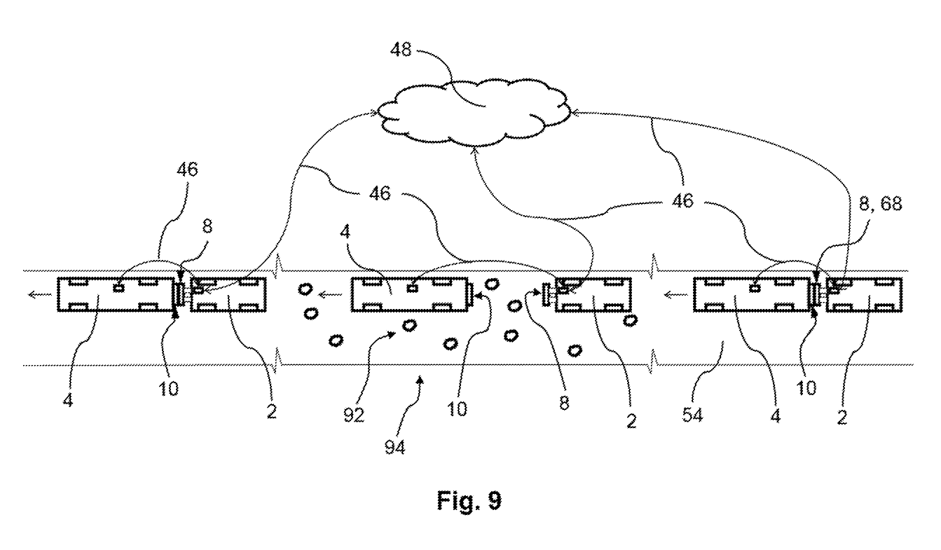

FIG. 9 schematically shows the sequence of the automatic decoupling and recoupling of a range extender vehicle 2 according to the invention to/from a main vehicle 4 during travel over a rough road surface 92. To this end, FIG. 9 shows from right to left three successive sequences of common travel of the range extender vehicle 2 and the main vehicle 4.

Initially, the range extender vehicle 2 and the main vehicle 4 drive on a road network 54 (right-hand portion of FIG. 9) in a coupled state. In this case, the range extender vehicle 2 supplies energy to the main vehicle 4 via the mutually coupled means 8 for transmitting energy and means 10 for obtaining energy. The range extender vehicle 2 and the main vehicle 4 can exchange information about a driving state via a radio connection 46.

In this instance, it is communicated to the range extender vehicle 2 via a radio connection 46 to a cloud database 48 that the planned travel path leads via a defined travel path portion 94, in this instance the rough road surface 92, and the range extender vehicle 2 forwards this information to the main vehicle 4. Travel over the rough road surface 92 in the coupled state would overload the coupling of the means 8 for transmitting energy and the means 10 for obtaining energy because a permissible range of movement of a coupling element 68 of the range extender vehicle 2 would be exceeded. Before the rough road surface 92 is reached, therefore, the means 8 for transmitting energy and the means 10 for obtaining energy are automatically decoupled.

Subsequently, the range extender vehicle 2 and the main vehicle 4 travel over the rough road surface 92 independently of each other (central portion of FIG. 9). Meanwhile, information can be exchanged via the radio connections 46 between the range extender vehicle 2 and the main vehicle 4 and the cloud database 48. In this case, a direct radio connection between the main vehicle 4 and the cloud database 48 can also be configured. In particular, the range extender vehicle 2 and the main vehicle 4 are in this case informed via a cloud-based control unit as soon as the rough road surface 92 has been passed. If desirable, the range extender vehicle 2 and/or the main vehicle 4 may have a local sensor system for automatically detecting rough road surfaces 92 or other driving situations which overload the coupling, such as, for example, evasive manoeuvres or overtaking manoeuvres; in this case, in principle a direct communication between the main vehicle 4 and the range extender vehicle 2 is sufficient for coordination in the case of travel over the rough road surface 92 or through the driving situation.

After the rough road surface 92 has been passed, the range extender vehicle 2 again approaches the main vehicle 4. The means 8 for transmitting energy and the means 10 for obtaining energy are again coupled to each other so that a supply of current to the main vehicle 4 by the range extender vehicle 2 can again be started (left-hand portion of FIG. 9). During this procedure, a main vehicle energy store must be selected to be so large that travel over the rough road surface 92 or through another driving situation which overloads the coupling is possible without energy being supplied from the range extender vehicle 2.

What is claimed is:

1. Use of a range extender vehicle having a range extender energy store, a means for transmitting energy to a main vehicle, and a range extender electric motor for driving the range extender vehicle, in order to supply a main vehicle, having a main vehicle electric motor for driving the main vehicle, a main vehicle energy store for supplying the main vehicle electric motor with current and means for obtaining energy from the range extender vehicle, with energy from the range extender energy store via the mutually coupled means for transmitting energy and means for obtaining energy, wherein the supply of the main vehicle with energy from the range extender energy store is carried out while the main vehicle drives on the road network, wherein the range extender vehicle comprises:
a means for autonomously driving the range extender vehicle on a road network; and
a receiving means for receiving information for locating the main vehicle, which drives on the road network without the range extender vehicle;
wherein the means for transmitting energy and the means for obtaining energy are constructed for a wireless, inductive energy transmission, in that, while the main vehicle is driving;
wherein the range extender vehicle, when an energy requirement is identified upon a request by the main vehicle, drives up to the main vehicle autonomously using information received via the receiving means, and subsequently the means for transmitting energy and the means for obtaining energy are automatically coupled to each other; and
after substantial depletion of the range extender energy store or after complete charging of the main vehicle energy store, the means for transmitting energy and the means for obtaining energy are automatically decoupled and subsequently the range extender vehicle autonomously drives away from the main vehicle, and in that, during the supply of the main vehicle with energy from the range extender energy store, the range extender vehicle and the main vehicle maintain only a resilient abutment contact in the travel direction, wherein the range extender vehicle drives autonomously.

2. Use of the range extender vehicle according to claim 1, wherein the range extender vehicle is kept at a charging station at the time of the request by the main vehicle.

3. Use of the range extender vehicle according to claim 2, wherein the range extender vehicle automatically returns to a charging station after decoupling of the means for transmitting energy and the means for obtaining energy.

4. Use of the range extender vehicle according to claim 3, wherein while the main vehicle is driving, the range extender vehicle is exchanged so that a plurality of range extender vehicles chronologically one after the other drive up to the main vehicle autonomously using information received via the receiving means, and subsequently the means for transmitting energy and the means for obtaining energy are automatically decoupled to each other; and wherein the means for transmitting energy and the means for obtaining energy are automatically decoupled and subsequently the range extender vehicle autonomously drives away from the main vehicle.

5. Use of the range extender vehicle according to claim 4, wherein the energy for a propulsion current of the main vehicle electric motor is provided by the range extender energy store while supplying the main vehicle with energy from the range extender energy store, wherein the energy for a charging current for recharging the main vehicle energy store is further also provided by the range extender energy store.

6. Use of the range extender vehicle according to claim 5, wherein the range extender vehicle gives up a coupling of the means for transmitting energy and the means for obtaining energy and configures a spacing between the range extender vehicle and the main vehicle before a defined travel path portion is reached or a defined travel situation occurs, and further maintains a spacing between the range extender vehicle and the main vehicle as long as the defined travel path portion is being passed or the defined driving situation continues, and configures the coupling of the means for transmitting energy and the means for obtaining energy again when the defined travel path portion has been left again or the defined driving situation has passed.

7. Use of the range extender vehicle according to claim 6, wherein the main vehicle also has a means for autonomously driving the main vehicle on the road network and wherein the main vehicle drives autonomously while the supply of the main vehicle with energy from the range extender energy store is being carried out.

8. Use of the range extender vehicle according to claim 7, wherein the main vehicle comprises a lorry.

9. The range extender vehicle according to claim 1, having the range extender energy store and the means for transmitting energy to the main vehicle, and the range extender electric motor for driving the range extender vehicle, wherein the range extender vehicle comprises:
the means for autonomously driving the range extender vehicle on a road network; and
the receiving means for receiving information for locating the main vehicle, which drives on the road network without the range extender vehicle;
wherein the means for transmitting energy are constructed for automatically coupling and decoupling to/from means for obtaining energy of the main vehicle;
wherein the means for transmitting energy comprise a coupling element which is arranged on one or more resilient extension arms which can be deployed mechanically parallel with the travel direction;
wherein the means for transmitting energy are constructed for a wireless, inductive energy transmission to means for obtaining energy of the main vehicle;
wherein the means for transmitting energy comprise an induction loop in an abutment element, wherein the abutment element is integrated in the coupling element.

10. The range extender vehicle according to claim 9, wherein it is constructed without a driver's seat.

11. The range extender vehicle according to claim 9, wherein at least 50% of the mass thereof and/or at least 50% of the volume thereof is allotted to the range extender energy store.

12. The range extender vehicle according to claim 9, wherein at least 75% of the mass thereof and/or at least 75% of the volume thereof is allotted to the range extender energy store.

13. The range extender vehicle according to claim 9, wherein the coupling element is arranged at the front on the range extender vehicle.

14. The range extender vehicle according to claim 9, wherein a means for mechanically adjusting the coupling element in terms of height are provided.

15. The range extender vehicle according to claim 9, wherein one or more magnets is/are constructed on the coupling element.
